(19) United States
(12) Patent Application Publication
(10) Pub. No.: US 2018/0063308 A1
(43) Pub. Date: Mar. 1, 2018

(54) System and Method for Voice Recognition

(71) Applicant: Bioworld Merchandising, Irving, TX (US)

(72) Inventors: Franz Crystal, Plano, TX (US); Weimin Peng, Plano, TX (US); Willie Baker, The Colony, TX (US); Michael Nolan, Chappaqua, NY (US)

(21) Appl. No.: 15/799,801

(22) Filed: Oct. 31, 2017

Related U.S. Application Data
(63) Continuation-in-part of application No. 15/440,633, filed on Feb. 23, 2017.
(60) Provisional application No. 62/298,515, filed on Feb. 23, 2016.

(51) Int. Cl. H04M 1/60; G10L 15/22; G06F 3/0346; G06F 3/01; H04M 19/04

(52) U.S. Cl. CPC H04M 1/6066; G10L 15/22; G06F 3/0346; G10L 2015/223; G06F 3/014; H04M 19/047; G06F 3/017

(57) ABSTRACT

In an embodiment, an apparatus includes: a motor; a master control unit coupled to the motor, the master control unit configured to: receive an indication of an incoming call from a mobile device; enable the motor and provide a haptic notification in response to receiving the indication of the incoming call; receive a first command to answer the incoming call; and forward the first command to the mobile device, the first command instructing the mobile device to answer the incoming call and transfer phone and audio functionality for the incoming call to a headset, the headset paired with the mobile device with a pre-established master/slave connection.

### CROSS-REFERENCE TO RELATED APPLICATIONS

This application is a continuation-in-part of U.S. patent application Ser. No. 15/440,633, filed on Feb. 23, 2017, which claims the benefit of U.S. Provisional Application No. 62/298,515, filed on Feb. 23, 2016, which applications are hereby incorporated herein by reference.

### BACKGROUND

Smartphone accessories such as headsets may communicate with the smartphone using a short-range voice transmission technology such as Bluetooth. An example application is a hands-free Bluetooth earpiece for a phone which may not be held to a user's ear. For example, the user may place their phone in their pocket, purse, or personal storage, and may use their Bluetooth earpiece to conduct a phone call.

### SUMMARY

In an embodiment, an apparatus includes: a motor; a master control unit coupled to the motor, the master control unit configured to: receive an indication of an incoming call from a mobile device; enable the motor and provide a haptic notification in response to receiving the indication of the incoming call; receive a first command to answer the incoming call; and forward the first command to the mobile device, the first command instructing the mobile device to answer the incoming call and transfer phone and audio functionality for the incoming call to a headset, the headset paired with the mobile device with a pre-established master/slave connection.

In some embodiments, the apparatus further includes: a motion sensor configured to capture the first command to answer the incoming call. In some embodiments, the apparatus further includes: a voice recognition integrated circuit configured to capture the first command to answer the incoming call, and forward the first command to enable the motion sensor to the master control unit. In some embodiments, the voice recognition integrated circuit is further configured to capture a second command to enable the motion sensor, and forward the second command to enable the motion sensor to the master control unit. In some embodiments, the phone and audio functionality are transferred to the headset without further input after forwarding the first command to the mobile device. In some embodiments, the master control unit, mobile device, and headset communicate over a short-range wireless network. In some embodiments, the short-range wireless network is a Bluetooth network. In some embodiments, the master control unit communicates with the mobile device over the Bluetooth network according to the Hands Free Profile (HFP) and the Human Interface Device (HID) profile, and does not communicate with the mobile device over the Bluetooth network according to the Audio/Video Remote Control Profile (AVRCP) or the Advanced Audio Distribution Profile (A2DP). In some embodiments, the apparatus further includes: a light emitting diode (LED) coupled to the master control unit, the master control unit configured to enable the LED in response to connecting to the short-range wireless network. In some embodiments, the master control unit includes: a networking device configured to communicate with the mobile device over the short-range wireless network; and a processing core configured to control the networking device.

In an embodiment, an apparatus includes: an article of clothing having a pocket, the pocket including a flap that secures the pocket when closed; and a voice recognition device disposed in the pocket of the article of clothing, the voice recognition device including a microphone, the voice recognition device configured to: receive a first signal from the microphone; select an instruction of a plurality of available instructions according to the first signal from the microphone; and interact with a device pairing according to the selected instruction, the device pairing being a pre-established master/slave connection between a mobile device and a headset device, where the voice recognition device, the headset device, and the mobile device are all different devices.

In some embodiments, the voice recognition device is further configured to: receive an indication of an incoming call from the mobile device; provide a haptic notification in response to receiving the indication of the incoming call; and after interacting with the device pairing, transfer phone and audio functionality to the headset device. In some embodiments, phone and audio functionality are transferred to the headset device without further input. In some embodiments, the article of clothing is a glove including: a palm section having the pocket; a dorsum section; a plurality of finger-retaining sections connected to the palm section and the dorsum section; and cuff connected to the palm section and the dorsum section. In some embodiments, the voice recognition device interacts with the device pairing by: forwarding the selected instruction to the mobile device over a short-range wireless network. In some embodiments, the short-range wireless network is a Bluetooth network. In some embodiments, the voice recognition device communicates with the mobile device over the Bluetooth network according to the Hands Free Profile (HFP) and the Human Interface Device (HID) profile, and does not communicate with the mobile device over the Bluetooth network according to the Audio/Video Remote Control Profile (AVRCP) or the Advanced Audio Distribution Profile (A2DP).

In an embodiment, a method includes: receiving, by voice recognition device, a first signal from a microphone; selecting, by voice recognition device, an instruction of a plurality of available instructions according to the first signal from the microphone; and interacting, by voice recognition device, with a device pairing according to the selected instruction, the device pairing being a pre-established master/slave connection between a mobile device and a headset device, where the voice recognition device, the headset device, and the mobile device are all different devices.

In some embodiments, the method further includes: receiving, by voice recognition device, an indication of an incoming call from the mobile device; providing, by voice recognition device, a haptic notification in response to receiving the indication of the incoming call; and after the interacting with the device pairing, transferring, by voice recognition device, phone and audio functionality to the headset device. In some embodiments, phone and audio functionality are transferred to the headset device without further input.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and 1B illustrate a glove, in accordance with some embodiments.

FIG. 2 illustrates a glove pocket, in accordance with some embodiments.

FIG. 3 illustrates a voice recognition module, in accordance with some embodiments.

FIG. 4 illustrates a voice recognition module when operating in conjunction with a smart phone and headset, in accordance with some embodiments.

FIG. 5 is a block diagram illustrating features of a voice recognition module, in accordance with some embodiments.

FIG. 6 shows a Bluetooth protocol stack, in accordance with some embodiments.

FIG. 7 is a method which may be performed by a voice recognition module, in accordance with some embodiments.

FIG. 8 is a method which may be performed by a voice recognition module, in accordance with some embodiments.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions, and alterations can be made herein without departing from the spirit and scope of this disclosure as defined by the appended claims.

Various embodiments are described within a specific context, namely a voice recognition module that interacts with a master/slave connection between a smart phone and a headset. The voice recognition module pairs with the smart phone via a short-range wireless network, such as Bluetooth. The Bluetooth stack of the voice recognition module is modified to include and exclude certain profiles. As such, the voice recognition module may be used to interact with the smart phone and headset, without disturbing the pre-established connection between the smart phone and headset.

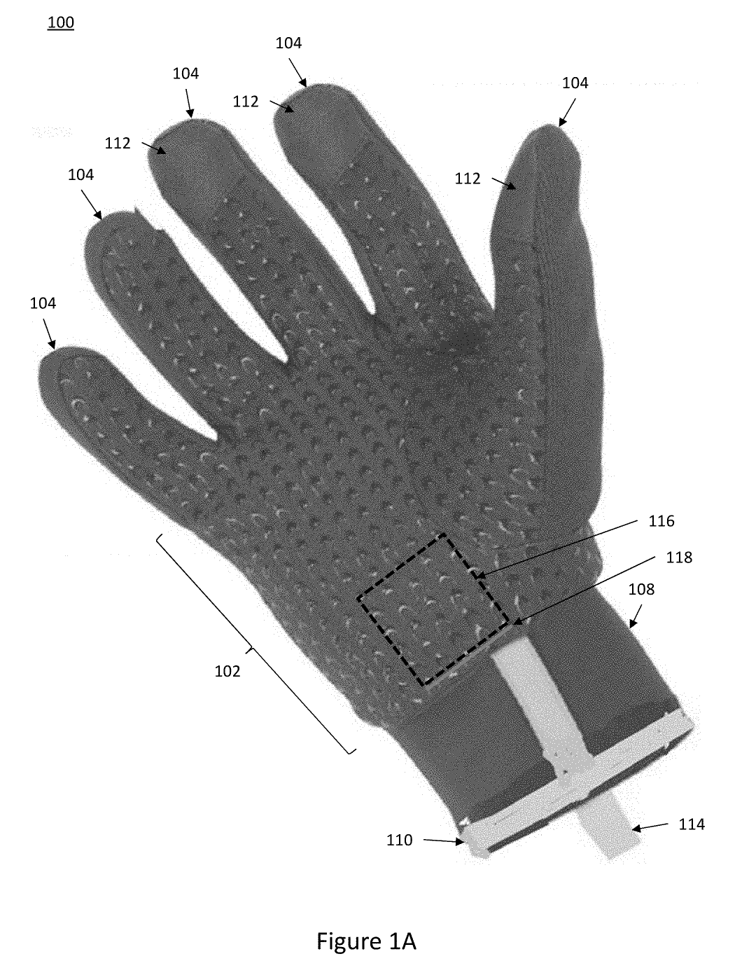

FIGS. 1A and 1B illustrate a glove 100, in accordance with some embodiments. The glove 100 includes a palm section 102, a plurality of finger-retaining sections 104, a dorsum section 106, and a cuff 108. The palm section 102 overlies the palm of the wearers hand, and extends between the finger-retaining sections 104 and the cuff 108 on the front of the wearers hand. The dorsum section 106 overlies the dorsum of the wearers hand, and extends between the finger-retaining sections 104 and the cuff 108 on the back of the wearers hand. Each of the finger-retaining sections 104 holds one digit of the wearers hand. The palm section 102, finger-retaining sections 104, and dorsum section 106 may be formed from a variety of materials, and each section may be formed from a plurality of materials. For example, portions of the finger-retaining sections 104 at the back of the wearers hand may (or may not) be formed from a different material than portions of the finger-retaining sections 104 at the front of the wearers hand. Further, the glove 100 may have a liner that is filled with a material. For example, in embodiments where the glove 100 is intended for use in cold weather, the liner may be filled with down.

In some embodiments, the palm section 102 and front portions of the finger-retaining sections 104 (e.g., shown in FIG. 1A) are formed from a screened material, such as a silicone screened material. A screened material may provide better grip for the wearer. In such embodiments, back portions of the finger-retaining sections 104 (e.g., shown in FIG. 1B) are formed from a softshell material. The softshell material may have a windproof and waterproof lining (or membrane). Further, the dorsum section 106 may be formed from several material. For example, a first portion of the dorsum section 106 (proximate the back portions of the finger-retaining sections 104) may be formed from the softshell material, and a second portion of the dorsum section 106 may be formed from a polyester stretch material that includes fleece. The cuff 108 may also be formed from the polyester stretch material.

The glove 100 may further include reflectors no. In an embodiment, the reflectors no are formed on the cuff 108 and the dorsum section 106. The reflectors may be formed from thermoplastic polyurethane (TPU). Use of the reflectors no improves safety of the wearer by making the glove 100 more visible in low-light situations.

The glove 100 may further include touch tips 112. The touch tips 112 may be formed from a different material than the material(s) of the finger-retaining sections 104, and allow the wearer to interact with a touchscreen device without removing the glove 100. For example, the touch tips 112 may be formed from over-molded conductive TPU, conductive threads, or the like.

The glove 100 may further include clips 114. The clips 114 may be ski clips, and may be formed of a hard material such as plastic or metal, or may be formed of a soft material such as elastic or cloth. The reflectors no may be formed on some or all portions of the clips 114.

Although the glove wo is described as having the palm section 102, finger-retaining sections 104, dorsum section 106, and cuff 108 formed from certain materials, it should be appreciated that these features may be formed of a variety of materials. For example, the glove wo illustrates in FIGS. 1A and 1B is an athletic glove for runners. In other embodiments, the glove wo maybe, e.g., a glove for skiing or a glove for general use.

In some embodiments, the palm section 102 and front portions of the finger-retaining sections 104 are formed from a non-slip material such as SureGrip. Fourchettes of the finger-retaining sections 104 may be a softshell material. The dorsum section 106 and portions of the finger-retaining sections 104 are formed from a waterproof, breathable, and moisture-wicking material such as Pertex. In such embodiments, the cuff 108 may be formed from, e.g., knit nylon.

In some embodiments, the palm section 102, finger-retaining sections 104, dorsum section 106, and cuff 108 are formed from a multi-layer material. For example, they may be part of a shell comprising a layer of poly pongee, a TPU membrane, and a layer of fleece.

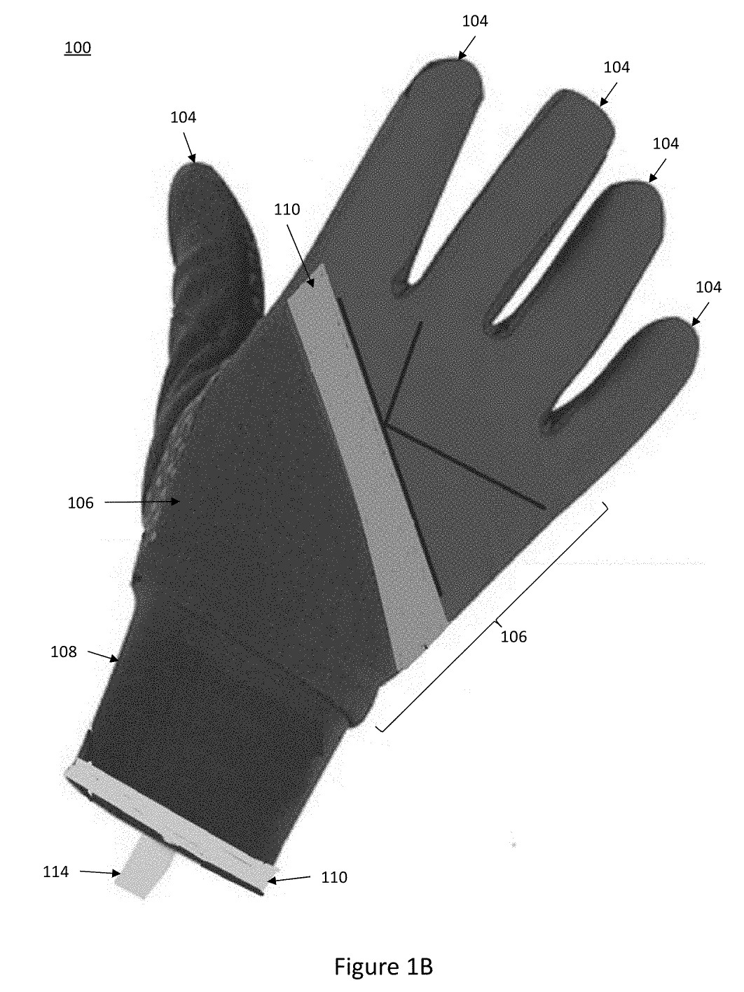

FIG. 2 illustrates a pocket 116, which is formed attached to the palm section 102. The pocket 116 is formed of a soft material such as polyester, and is attached to the inside of the palm section 102. The pocket 116 has an opening that is accessed through a slit 118 in the palm section 102. The pocket 116 and has a width W₁, height H₁, and depth D₁ to accommodate a voice recognition module (discussed below). In an embodiment, the width W₁ is about 2 inches, the height H₁ is about 2.5 inches, and the depth D₁ is about 0.25 inches.

The pocket 116 has a flap 120 that secures the pocket 116 when closed. The flap 120 is secured shut with fasteners 122. In an embodiment, the fasteners 122 are hook-and-loop fasteners such as Velcro. In some embodiments, the fasteners 122 may be buttons, zippers or any suitable fastener for securing the voice recognition module.

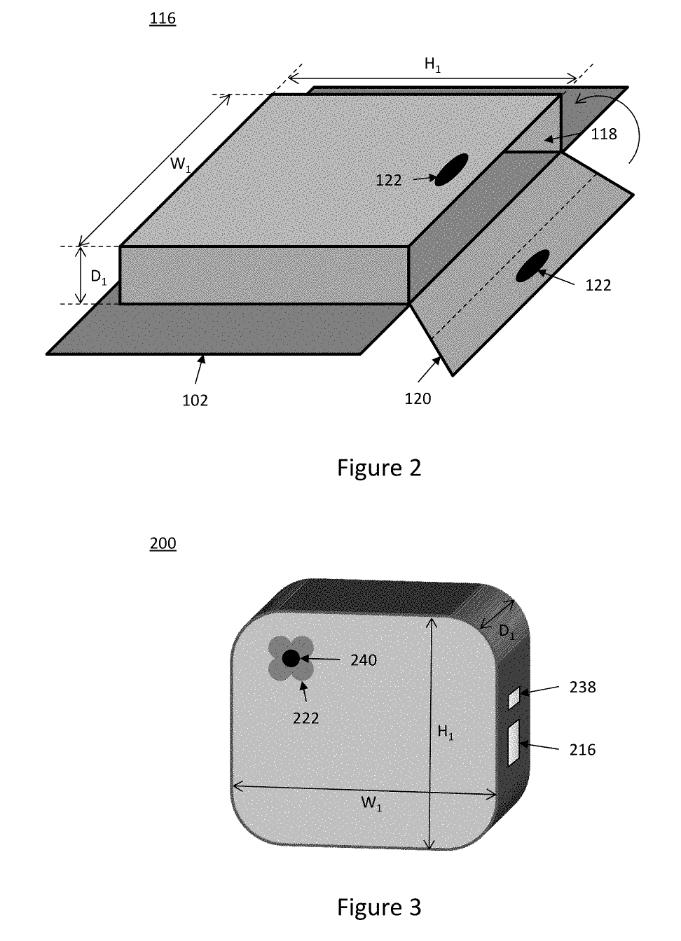

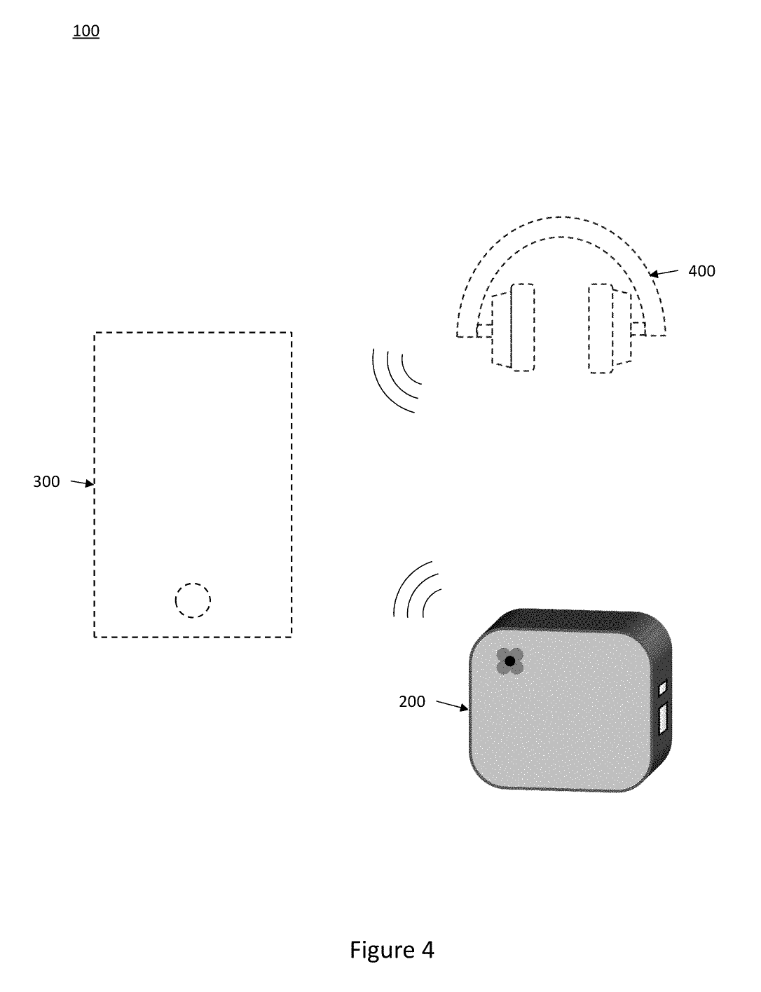

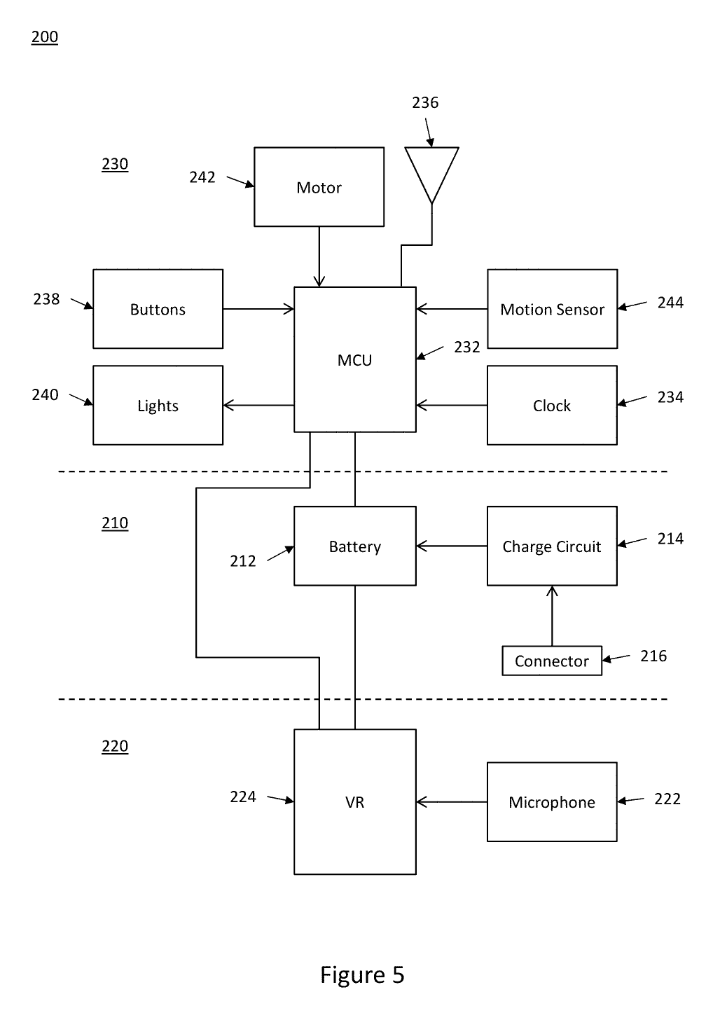

FIG. 3 illustrates a voice recognition module 200, in accordance with some embodiments. FIG. 4 illustrates the voice recognition module 200 when operating in conjunction with a smart phone 300 and headset 400. Details of the voice recognition module 200 will be discussed below with respect to FIG. 5. The smart phone 300 may be, for example, an Android or iPhone smart phone. The headset 400 is a personal headset, such as a wired or wireless headset. In an embodiment, the headset 400 is a Bluetooth headset and pairs with the smart phone 300 as a primary Bluetooth device. The voice recognition module 200 pairs to the smart phone 300 as a secondary Bluetooth device. The voice recognition module 200 interacts with the existing point-to-point (e.g., master/slave) Bluetooth connection between the smart phone 300 and headset 400 without taking over or modifying the connection. In other words, a user may interact with the smart phone 300 and headset 400 without breaking the existing connectivity of the devices. As such, the voice recognition functionality of the voice recognition module 200 may be used to control the smart phone 300 while retaining compatibility with any headset 400 chosen by the user.

The voice recognition module 200 may be deployed into any apparel or article of clothing, such as the glove 100. In an embodiment, the voice recognition module 200 is disposed in the pocket 116. In other embodiments, the voice recognition module 200 may be deployed into backpack straps, hats, wallets, or the like. Further, it should be appreciated that the pocket 116 may be formed attached to other components of the glove 100, such as the dorsum section 106.

The voice recognition module 200 allows control of the smart phone 300 by voice recognition, and provides partial controls for the audio portion of the smart phone 300, without taking over full control of the smart phone 300. The voice recognition module 200 allows the user to activate and control several primary functions of the smart phone 300, such as audio output, without the need to handle the smart phone 300 or remove the smart phone 300 from a pocket, purse, or personal storage. The voice recognition module 200 allows the user to use the headset 400 (which has a pre-established connection with the smartphone), and provides a voice recognition input to answer or reject calls as well as provide voice control for many other commands that may be used to interact with the smart phone 300. For example, the user may use voice commands to: answer calls; hang up a connected call; reject an incoming call; turn volume up on the headset 400; turn volume down on the headset 400; play music through a music app of the smart phone 300; pause music; replay the previous song in a queue; advance to the next song in the queue.

FIG. 5 is a block diagram illustrating features of the voice recognition module 200, and is described in conjunction with FIGS. 3 and 4. The voice recognition module 200 includes a power subsystem 210, an audio subsystem 220, and a processing subsystem 230. The power subsystem 210 provides power to the audio subsystem 220 and processing subsystem 230. The audio subsystem 220 captures sound, such as verbal commands from the user, and sends a corresponding instruction to the processing subsystem 230. The processing subsystem 230 then interacts with the device pairing between the smart phone 300 and headset 400 by, e.g., transmitting the selected instruction to the smart phone 300.

The power subsystem 210 stores and provides power for the voice recognition module 200. The power subsystem 210 includes a battery 212, a charge circuit 214, and a connector 216. The battery 212 stores charge and may be, e.g., a lithium-ion (Li-ion) battery. The charge circuit 214 controls charging of the battery 212, and provides overcharging protection by automatically shutting off the charging process when the battery 212 attains a full charge. The charge circuit 214 may also measure the status or charge of the battery 212, and report it to the processing subsystem 230 for relaying to the smart phone 300. The connector 216 is an external interface for the charge circuit 214, and may be, e.g., a USB connector or a magnet.

The audio subsystem 220 captures sound and produces an audio signal. An instruction is selected from a list of predefined instructions according to the audio signal. The audio subsystem 220 includes a microphone 222 and a voice recognition integrated circuit 224. The microphone 222 captures the audio signal and may be, e.g., a MEMS microphone, although other types of microphones could be used. The voice recognition integrated circuit 224 receives the audio signal, and selects an instruction of a plurality of available instructions. The available instructions correspond to the voice commands that the user may speak, such as instructions for: answering the phone; hanging up the phone; rejecting a phone call; increasing the volume; decreasing the volume; playing a song; pausing a song; replaying a previous song; and skipping to a subsequent song. The voice recognition integrated circuit 224 may be, e.g., a system-on-chip (SoC), such as a Nuvoton ISD9160. The voice recognition integrated circuit 224 is configured to analyze the audio signal and select an instruction from the available instructions from, e.g., with a lookup table. The selected instruction is transmitted to the processing subsystem 230.

The processing subsystem 230 receives the selected instruction from the voice recognition integrated circuit 224 and transmits it to the smart phone 300. The processing subsystem 230 includes a master control unit 232, a clock 234, and an antenna 236. The master control unit 232 may be a SoC that includes a processing core and a networking device, such as a Qualcomm BC57E687B. The processor core may be, e.g., an ARM Cortex processor, and handles input/output (I/O) with the smart phone 300. The networking device may be, e.g., a Bluetooth chipset. A clock 234 provides a reference clock for the master control unit 232, and may be, e.g., a 32.786 kHz crystal quartz. The antenna 236 is connected to the Bluetooth chipset, and is used to transmit/receive information to/from the smart phone 300. In some embodiments, the antenna 236 is part of the master control unit 232. The master control unit 232 receives the selected instruction from the audio subsystem 220, and sends it to the smart phone 300 by the antenna 236. In accordance with an embodiment, the Bluetooth chipset of the master control unit 232 has a modified Bluetooth protocol stack 500 (discussed further below).

In some embodiments, the processing subsystem 230 further includes buttons 238. The buttons 238 are disposed on sides of the voice recognition module 200. The buttons 238 may include buttons for powering the voice recognition module 200 on/off, and buttons for pairing the voice recognition module 200 with the smart phone 300.

In some embodiments, the processing subsystem 230 further includes a light 240. The light 240 may be, e.g., a light emitting diode (LED). The light 240 may indicate the power state of the voice recognition module 200 (e.g., on/off). The light 240 may also indicate whether the voice recognition module 200 is paired with the smart phone 300.

In some embodiments, the processing subsystem 230 further includes a motor 242. The motor 242 is connected to a vibrator and may be used to provide haptic feedback to the user of the smart phone 300. When the smart phone 300 receives a call, the master control unit 232 receives a notification of an incoming call from the smart phone 300, e.g., via Bluetooth. In response to receiving the notification of the call, the master control unit 232 turns on the motor 242 to vibrate and alert the user of the incoming call. The motor 242 may stop vibrating after a predetermined amount of time elapses, giving the user an opportunity to provide a verbal command. If the master control unit 232 does not receive a verbal command, the motor 242 may be turned on again and another vibration notification may be performed. The master control unit 232 may provide vibration notifications until the incoming call is answered or rejected, or until a predetermined amount of vibration notifications are performed.

In some embodiments, the processing subsystem 230 further includes a motion sensor 244. The motion sensor 244 detects position data of the glove 100, thereby determining trajectory and/or speed of a motion performed by the wearer of the glove 100. For example, the motion sensor 244 can include a velocity sensor, a GPS location sensor, a displacement sensor, an accelerometer and/or the like. The motion sensor 244 may include a motion detecting circuit for generating an electronic output corresponding to a sensed motion pattern, and a communication circuit for communicating the electronic output to the master control unit 232.

The motion patterns may also correspond to the available instructions that may be performed by the user. For example, the motion pattern includes circular clockwise movement, circular counter clockwise movement, movement right, movement left, movement up, movement down, movement forward, movement backward, waving movement, or a combination thereof. Each motion pattern or a combination of motion patterns corresponds to a command. For example, a clockwise circular motion corresponds to answering an incoming phone call. A counter clockwise circular motion corresponds to disconnecting a phone call. A linear motion to the right direction corresponds to turning up a volume. A linear motion to the left direction corresponds to turning down a volume. The speed of the motion can also be taken into account when determining a type of command. For example, a same type of motion (e.g., linear right, linear left, clockwise circular, clockwise circular motion) with a higher speed (e.g., speed greater than certain value) and a lower speed (e.g., speed less than certain value) can correspond to different type of command.

Motion pattern recognition may be enabled and disabled. For example, the user may enabled or disabled motion pattern recognition with a voice command. This allows motion pattern recognition to be disabled in situations where the user may not desire it, such as when using the glove 100 during in high-motion activities such as exercise or sporting.

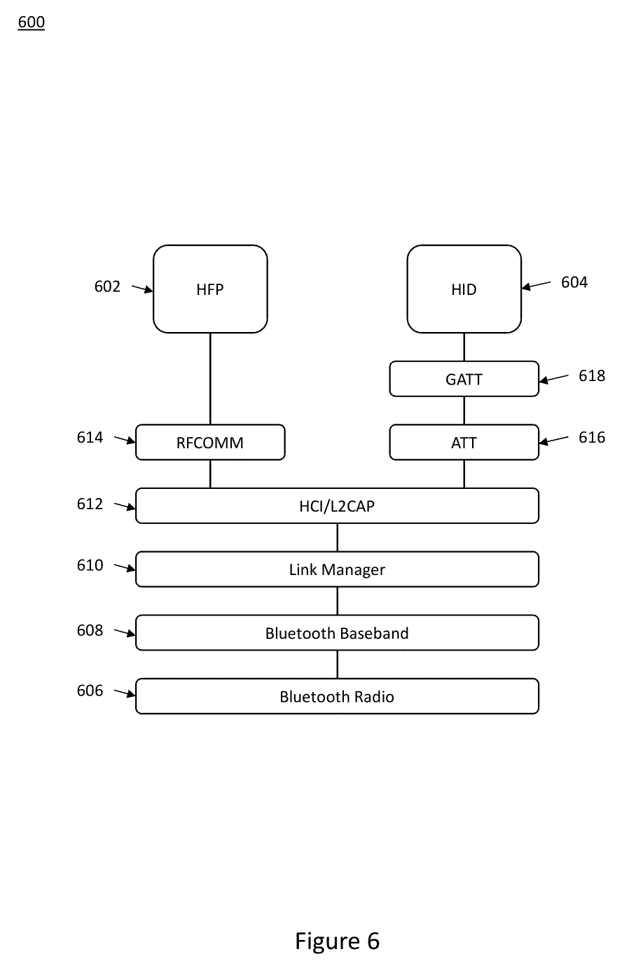

FIG. 6 shows a Bluetooth protocol stack 600, in accordance with some embodiments. The Bluetooth protocol stack 600 is a modified stack that supports several profiles and, optionally, omits other profiles. The voice recognition module 200 communicates with the smart phone 300 using the profiles of the Bluetooth protocol stack 600. In particular, the Bluetooth protocol stack 600 includes the Hands Free Profile (HFP) 602 and the Human Interface Device (HID) profile 604. The HFP 602 is used to interact with phone functions of the smart phone 300, such as answering a call, hanging up a call, or rejecting a call. The HID profile 604 is used to interact with audio functions of the smart phone 300, such as adjusting the volume or controlling music playback.

In accordance with some embodiments, the HFP 602 of the Bluetooth protocol stack 600 is configured to automatically transfer an incoming call to the smart phone 300 or headset 400, in response to the call being answered. For example, when the incoming call is answered (e.g., by the user issuing a voice command), the voice recognition module 200 transmits an instruction to the smart phone 300, instructing it to answer the call. Subsequently, and without user interaction, the voice recognition module 200 transmits an instruction to the smart phone 300, instructing it to use the smart phone 300 or headset 400 for the call. As such, phone call functionality may be left at the smart phone 300 or headset 400 when a call is answered, and the audio subsystem 220 of the voice recognition module 200 is not used for conducting the phone call.

In accordance with some embodiments, the HID profile 604 of the Bluetooth protocol stack 600 is configured to interact with the audio functionality of the smart phone 300. For example, commands for increase or decreasing the volume of the smart phone 300 may be sent with the HID profile 604. Likewise, commands for controlling music playback may be sent with the HID profile 604. The HID profile 604 in the Bluetooth protocol stack 600 is not configured to transmit commands from a mouse or keyboard.

As noted above, the Bluetooth protocol stack 600 includes the HFP 602 and HID profile 604. The Bluetooth protocol stack 600 may not include other profiles, or may exclude certain profiles. In some embodiments, the Bluetooth protocol stack 600 only includes the HFP 602 and HID profile 604, and omits all other profiles. In some embodiments, the Bluetooth protocol stack 600 includes the HFP 602 and HID profile 604, and omits (e.g., disables) the Audio/Video Remote Control Profile (AVRCP) (not shown) and the Advanced Audio Distribution Profile (A2DP) (not shown). Omitting the AVRCP and A2DP allows the voice recognition module 200 to interact with the existing connection between the smart phone 300 and headset 400, while not requiring the voice recognition module 200 be used for phone and audio functions of the smart phone 300. As such, the voice recognition module 200 may be used to control the smart phone 300 while the headset 400 is used for phone and audio functions.

In the Bluetooth protocol stack 600, the radio 606 transmits and receives signals, and may be part of the master control unit 232. The baseband 608 and link manager 610 abstract the transmission of packets from the radio 606. The host controller interface (HCI) and Logical link control and adaptation protocol (L2CAP) (HCI/L2CAP) 612 decouple the higher layer protocols from the lower layers of the controller. The HFP 602 is bound to the HCI/L2CAP 612 by the radio frequency communication (RFCOMM) protocol 614. The HID profile 604 is bound to the HCI/L2CAP 612 by the Low Energy Attribute Protocol (ATT) 616 and the Generic Attribute (GATT) profile 618. Details about these protocols are standardized as IEEE 802.15.1, and are not repeated herein.

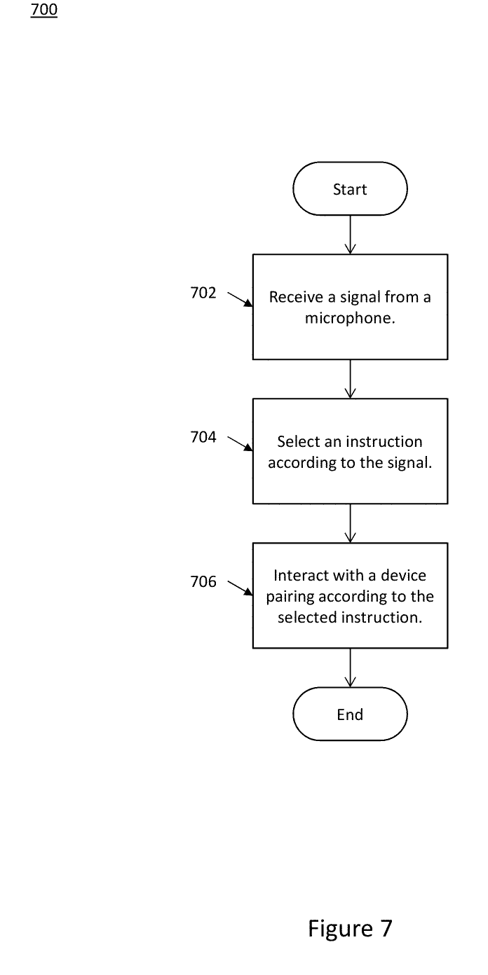

FIG. 7 is a method 700, which may be performed by the voice recognition module 200. The method 700 is performed when the user issues a verbal command to the voice recognition module 200 to control the phone or audio functions of the smart phone 300.

In step 702, a signal is received from the microphone 222. The signal is captured by the microphone 222, and may be an analog waveform representing a recording of the verbal command spoken by the user.

In step 704, an instruction is selected from a plurality of available instructions, according to the signal from the microphone. The instruction may be selected by, e.g., the voice recognition integrated circuit 224. As noted above, the available instructions include commands that interact with the phone functions or audio functions of the smart phone 300, such as answering an incoming call or controlling music playback. In some embodiments, the voice recognition integrated circuit 224 is a digital signal processing circuit that analyzes the signal from the microphone 222, and selects an instruction from the available instructions.

In step 706, a device pairing is interacted with according to the selected instruction. Interacting with the device pairing includes forwarding the selected instruction to the smart phone 300. The device pairing that the voice recognition module 200 interacts with is a pre-established master/slave connection, such as the connection between the smart phone 300 and headset 400. Notably, the voice recognition module 200, smart phone 300, and headset 400 are all different devices. As such, the voice recognition module 200 interacts with the smart phone 300 and headset 400, without transferring phone or audio functions from the existing pairing to the voice recognition module 200. Advantageously, this allows the smart phone 300 to be interacted without physically accessing the smart phone 300.

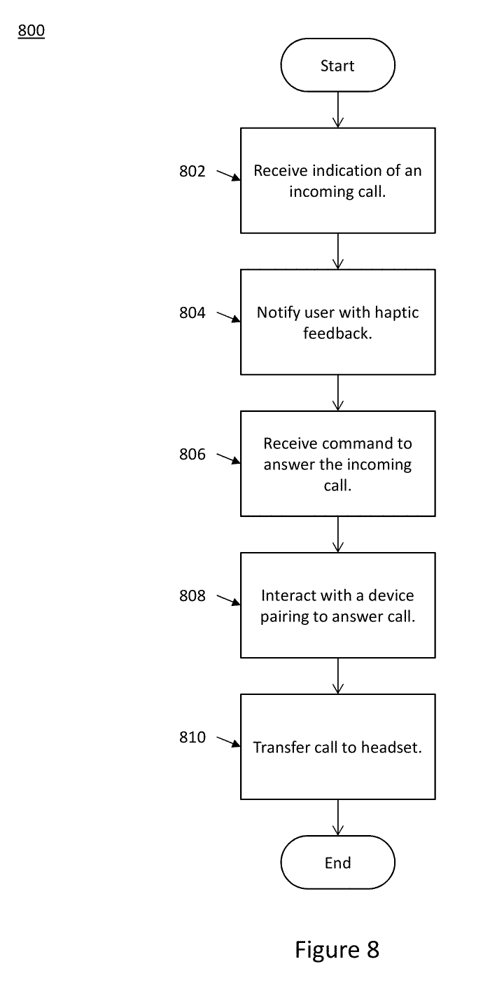

FIG. 8 is a method 800, which may be performed by the voice recognition module 200. The method 800 is performed when the user issues a command to the voice recognition module 200 to control the phone functions of the smart phone 300 in response to the smart phone 300 receiving an incoming call. The command may be a verbal command transduced by the microphone 222, or a motion pattern command transduced by the motion sensor 244.

In step 802, an indication is received, indicating that the smart phone 300 is receiving an incoming call. The indication may be sent to the voice recognition module 200 from the smart phone 300 via Bluetooth.

In step 804, the user is notified of the incoming call. The user may be notified via haptic feedback by enabling the motor 242. As discussed above, the notifications may be repeated a predetermined quantity of times, or until the incoming call is answered.

In step 806, a command is received to answer the incoming call. The command may be a verbal command transduced by the microphone 222, or a motion pattern command transduced by the motion sensor 244. In embodiments where the command is transduced by the microphone 222, the voice recognition module 200 selects an instruction according to the transduced audio signal. In embodiments where the command is transduced by the motion sensor 244, the master control unit 232 selects an instruction according to the transduced motion pattern.

In step 808, the device pairing between the smart phone 300 and headset 400 is interacted with to answer the incoming call. Interacting with the device pairing includes forwarding the selected instruction to the smart phone 300. For example, when the selected instruction is an instruction to answer the incoming call, the voice recognition module 200 sends the instruction to the smart phone 300 over Bluetooth so that the smart phone 300 answers the incoming call.

In step 810, the call is transferred to the headset 400, such that the call is conducted with the headset 400. The call is transferred without user interaction. For example, after the incoming call is answered, audio function is left with the smart phone 300 or its pre-connected audio accessories, such as the headset 400. This may be accomplished by the voice recognition module 200 transmitting an instruction to the smart phone 300, instructing it to use the headset 400 for conducting the phone call, without user interaction. As such, the audio subsystem 220 of the voice recognition module 200 is not used for conducting the phone call.

Embodiments may achieve advantages. Modifying the Bluetooth protocol stack 600 to include the HFP and HID and remove the AVRCP and A2DP allows the voice recognition module 200 to interact with the smart phone 300, while allowing the smart phone 300 and headset 400 to be used for phone and audio functionality. The voice recognition module 200 may thus be paired to the smart phone 300 and used to control the smart phone 300 without disturbing the pre-established master/slave connection between the smart phone 300 and headset 400.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An apparatus comprising:
a motor;
a master control unit coupled to the motor, the master control unit configured to:
receive an indication of an incoming call from a mobile device;
enable the motor and provide a haptic notification in response to receiving the indication of the incoming call;
receive a first command to answer the incoming call; and
forward the first command to the mobile device, the first command instructing the mobile device to answer the incoming call and transfer phone and audio functionality for the incoming call to a headset, the headset paired with the mobile device with a pre-established master/slave connection.

2. The apparatus of claim 1, further comprising:
a motion sensor configured to capture the first command to answer the incoming call.

3. The apparatus of claim 2, further comprising:
a voice recognition integrated circuit configured to capture the first command to answer the incoming call, and forward the first command to enable the motion sensor to the master control unit.

4. The apparatus of claim 3, wherein the voice recognition integrated circuit is further configured to capture a second command to enable the motion sensor, and forward the second command to enable the motion sensor to the master control unit.

5. The apparatus of claim 1, wherein the phone and audio functionality are transferred to the headset without further input after forwarding the first command to the mobile device.

6. The apparatus of claim 1, wherein the master control unit, mobile device, and headset communicate over a short-range wireless network.

7. The apparatus of claim 6, wherein the short-range wireless network is a Bluetooth network.

8. The apparatus of claim 7, wherein the master control unit communicates with the mobile device over the Bluetooth network according to the Hands Free Profile (HFP) and the Human Interface Device (HID) profile, and does not communicate with the mobile device over the Bluetooth network according to the Audio/Video Remote Control Profile (AVRCP) or the Advanced Audio Distribution Profile (A2DP).

9. The apparatus of claim 6, further comprising:
a light emitting diode (LED) coupled to the master control unit, the master control unit configured to enable the LED in response to connecting to the short-range wireless network.

10. The apparatus of claim 6, wherein the master control unit comprises:
a networking device configured to communicate with the mobile device over the short-range wireless network; and
a processing core configured to control the networking device.

11. An apparatus comprising:
an article of clothing having a pocket, the pocket comprising a flap that secures the pocket when closed; and
a voice recognition device disposed in the pocket of the article of clothing, the voice recognition device comprising a microphone, the voice recognition device configured to:
receive a first signal from the microphone;
select an instruction of a plurality of available instructions according to the first signal from the microphone; and
interact with a device pairing according to the selected instruction, the device pairing being a pre-established master/slave connection between a mobile device and a headset device, wherein the voice recognition device, the headset device, and the mobile device are all different devices.

12. The apparatus of claim 11, wherein the voice recognition device is further configured to:
receive an indication of an incoming call from the mobile device;
provide a haptic notification in response to receiving the indication of the incoming call; and
after interacting with the device pairing, transfer phone and audio functionality to the headset device.

13. The apparatus of claim 12, wherein phone and audio functionality are transferred to the headset device without further input.

14. The apparatus of claim 11, wherein the article of clothing is a glove comprising:
a palm section having the pocket;
a dorsum section;
a plurality of finger-retaining sections connected to the palm section and the dorsum section; and
cuff connected to the palm section and the dorsum section.

15. The apparatus of claim 11, wherein the voice recognition device interacts with the device pairing by:
forwarding the selected instruction to the mobile device over a short-range wireless network.

16. The apparatus of claim 15, wherein the short-range wireless network is a Bluetooth network.

17. The apparatus of claim 16, wherein the voice recognition device communicates with the mobile device over the Bluetooth network according to the Hands Free Profile (HFP) and the Human Interface Device (HID) profile, and does not communicate with the mobile device over the Bluetooth network according to the Audio/Video Remote Control Profile (AVRCP) or the Advanced Audio Distribution Profile (A2DP).

18. A method comprising:
receiving, by voice recognition device, a first signal from a microphone;
selecting, by voice recognition device, an instruction of a plurality of available instructions according to the first signal from the microphone; and
interacting, by voice recognition device, with a device pairing according to the selected instruction, the device pairing being a pre-established master/slave connection between a mobile device and a headset device, wherein the voice recognition device, the headset device, and the mobile device are all different devices.

19. The method of claim 18, further comprising:
receiving, by voice recognition device, an indication of an incoming call from the mobile device;
providing, by voice recognition device, a haptic notification in response to receiving the indication of the incoming call; and
after the interacting with the device pairing, transferring, by voice recognition device, phone and audio functionality to the headset device.

20. The method of claim 19, wherein phone and audio functionality are transferred to the headset device without further input.
